(19) United States
(12) Patent Application Publication
(10) Pub. No.: US 2013/0033116 A1
(43) Pub. Date: Feb. 7, 2013

(54) Power detecting circuit with fast power removing detection, electronic device and method thereof

(71) Applicants: Ching-Yuan Hsu, Hsinchu County (TW); Chin-Sen Chang, Hsinchu County (TW)

(72) Inventors: Ching-Yuan Hsu, Hsinchu County (TW); Chin-Sen Chang, Hsinchu County (TW)

(21) Appl. No.: 13/196,901

(22) Filed: Aug. 3, 2011

(51) Int. Cl. H02J 1/00

(52) U.S. Cl. 307/86

(57) ABSTRACT

A power detecting circuit with fast power removing detection is disclosed. The power detecting circuit comprises an isolating device, coupled between an external power source and an internal power source, for isolating the external power source, and the internal power source, and a comparator, coupled to the external power source, for determining if the external power source is removed, and accordingly generating a removing signal.

### BACKGROUND OF THE INVENTION

1. Field of the Invention

The present invention relates to a power detecting circuit, and more particularly, to a power detecting circuit with fast power removing detection.

2. Description of the Prior Art

FIG. 1 shows a conventional mechanism for detecting power removal. The external power source 160 is coupled to an electronic device 100 to provide an input power source VIN. The electronic device 100 comprises a comparator 120, an internal circuit 130, a resistor R1, a resistor R2 and a capacitor C. The capacitor C is coupled between an internal power source VDD and a ground end, for stabilizing the internal power source VDD. The internal power source VDD is utilized to providing power to the internal circuit 130 such that the internal circuit 130 operates. The comparator 120 includes an input end I1 and an input end I2. The resistor R1 is coupled between the input power source VIN and the input end I1 of the comparator 120; the resistor R2 is coupled between the input end I1 of the comparator 120 and the ground end. The resistors R1 and R2 are used to provide a divided power source VDIV from the input power source VIN to the input end I1 of the comparator 120.

The comparator 120 determines if the external power source 160 is removed according to a voltage of the divided power source VDIV, and accordingly generates a removing signal SPL to the internal circuit 130. In FIG. 1, the internal power source VDD and the input power source VIN are the same. When the internal circuit 130 receives the removing signal SPL representing “removing”, the internal circuit 130 prepares to turn off, e.g., sends a message to external devices, finishes unfinished operations, and stores unstored data, and then turns off.

The comparator 120 compares the voltage of the divided power source VDIV with a reference voltage VREF which is inputted to the input end I2 of the comparator 120. When the voltage of the divided power source VDIV is higher than the reference voltage VREF, it means the external power source 160 is still coupled to the electronic device 100, and thus the internal circuit 130 continues to operate regularly. When the voltage of the divided power source VDIV is lower than the reference voltage VREF, it means the external power source 160 is removed from the electronic device 100, and at meantime the comparator 120 generates the removing signal SPL representing “removing” to the internal circuit 130. Since the capacitor C in the electronic device 100 is disposed for stabilizing the internal power source VDD, after the external power source 160 is removed, the internal power source VDD can still provide power to the internal circuit 130 for a predetermine period TP. The internal circuit 130 finishes the unfinished operations and stored the unstored data during the predetermined period TP as soon as possible.

It can be known from the above illustration that the longer the predetermined period TP is, the more unfinished operations the internal circuit 130 can execute and the more unstored data the internal circuit 130 can store. That is, if the removal of the external power source 160 is detected earlier, or the internal power source VDD lasts longer, the predetermined period TP is longer. To last the internal power source VDD longer, the capacitor C has to be larger, and thus more space is occupied and the cost increases. To detect the removal of the external power source 160 earlier, the divided power source VDIV should be decreased. However, if the divided power source VDIV is decreased too low, the noise on the input power source VIN may trigger the comparator 120 to generate the removing signal SPL representing “removing” to the internal circuit 130, and the internal circuit 130 will get a false alarm and operate incorrectly. Therefore, in the prior art, both solutions will not only increase cost and space but also increase design difficulties.

### SUMMARY OF THE INVENTION

The present invention therefore provides a power detecting circuit with fast power removing detection, an electronic device and method thereof to solve the abovementioned problems.

A power detecting circuit with fast power removing detection is disclosed. The power detecting circuit comprises an isolating device, coupled between an external power source and an internal power source, for isolating the external power source and the internal power source, and a comparator, coupled to the external power source, for determining if the external power source is removed, and accordingly generating a removing signal; wherein the internal power source is provided to an internal circuit, the comparator is coupled to the internal circuit, and the internal circuit prepares to turn off and turns off according to the removing signal.

An electronic device with fast power removing detection is disclosed. The electronic device comprises an internal power source, for receiving an external power source for accordingly providing power, an internal circuit, coupled to the internal power source for receiving the power provided by the internal power source, to operate, prepare to turn off and turn off according to a removing signal, and a power detecting circuit. The power detecting circuit comprises an isolating device, coupled between the external power source and the internal power source, for isolating the external power source and the internal power source, and a comparator, coupled to the external power source, for determining if the external power source is removed, and accordingly generating the removing signal.

A method of handling fast power removing detection for an electronic device is disclosed. The method comprises detecting if an external power source is removed, and accordingly generating a removing signal, and preparing to turnoff and turning off an internal circuit of the electronic device according to the removing signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows the conventional mechanism for detecting power removal.

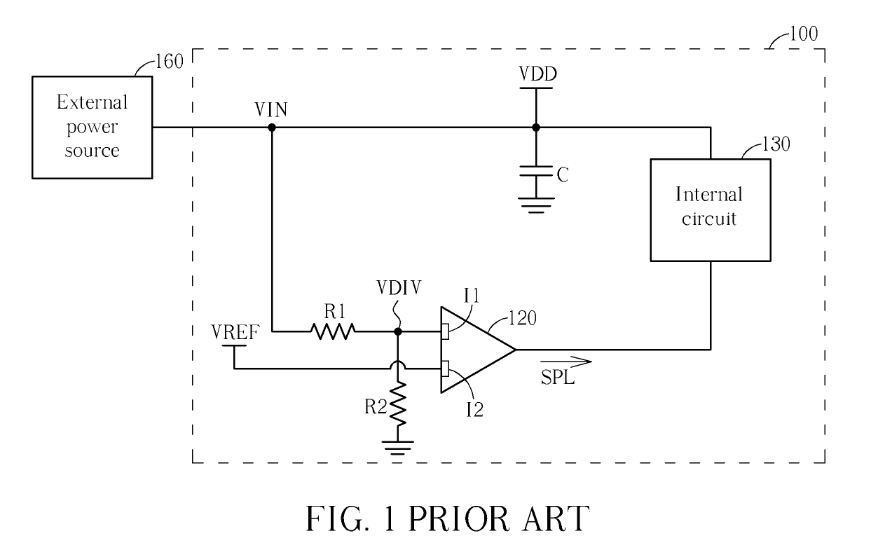

FIG. 2 shows electronic device with fast power removing detection according to a first embodiment of the present invention.

FIG. 3 shows electronic device with fast power removing detection according to a second embodiment of the present invention.

### DETAILED DESCRIPTION

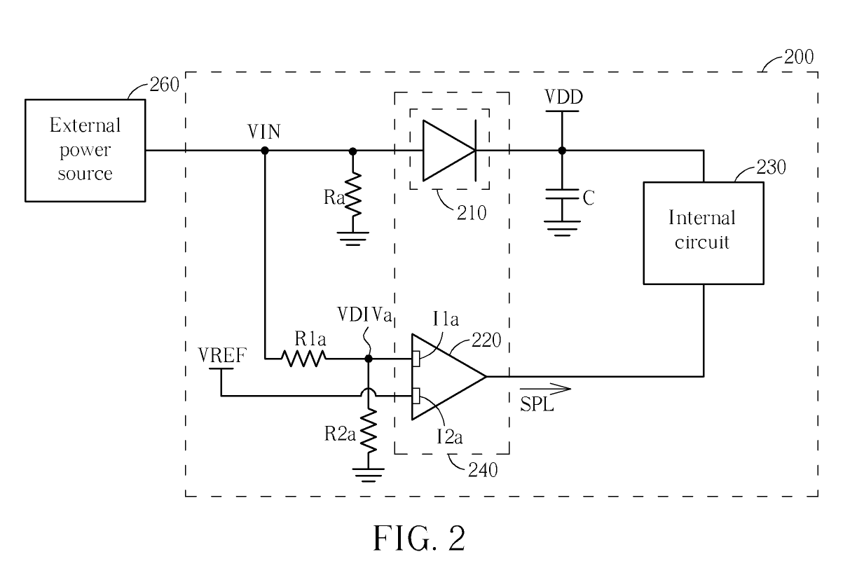

FIG. 2 shows an electronic device 200 with fast power removing detection according to the present invention. The electronic device 200 comprises an internal circuit 230, a resistor Ra, a resistor R1a, a resistor R2a, a capacitor C, and a power detecting circuit 240. The power detecting circuit 240 comprises an isolating device 210 and a comparator 220 which includes an input end I1a and an input end I2a. Additionally, an external power source 260 is coupled to the electronic device 200 for providing an input power source VIN.

The isolating device 210 of the power detecting circuit 240 isolates the input power source VIN provided by the external power source 260, and accordingly generates an internal power source VDD. In other words, the input power source VIN is converted to the internal power source VDD by the isolating device 210 of the power detecting circuit 240. The isolating device 210 is preferably realized by using a diode. The capacitor C is disposed for stabilizing the internal power source VDD so as to maintain the internal power source VDD for awhile after the external power source 260 is removed. The resistor Ra is coupled between the input power source VIN and a ground end, and is used to speed up discharge of the input power source VIN when the external power source 260 is removed. The resistor R1a is coupled between the input power source VIN and the input end I1a of the comparator 220; the resistor R2a is coupled between the input end I1a of the comparator 220 and the ground end. The resistors R1a and R2a are used to provide a divided power source VDIVa from the input power source VIN to the input end I1a of the comparator 220.

The comparator 220 determines if the external power source 260 is removed according to a voltage of the divided power source VDIVa, and accordingly sends a removing signal SPL representing “removing” to the internal circuit 230. When the internal circuit 230 receives the removing signal SPL representing “removing”, the internal circuit 230 prepares to turn off, e.g., finishing unfinished operations and stores unstored data, and then turns off.

The comparator 220 compares the voltage of the divided power source VDIVa with a reference voltage VREF which is inputted to the input end I2a of the comparator 220. When the divided voltage VDIVa is higher than the reference voltage VREF, it means the external power source 260 is still coupled to the electronic device 200 and thus the internal circuit 230 continues to operate regularly. When the voltage of the divided power source VDIVa is lower than the reference voltage VREF, it means the external power source 260 is removed from the electronic device 200, and the comparator 220 immediately sends the removing signal SPL representing “removing” to the internal circuit 230. The comparator 220 detects the drop of the voltage of the divided power source VDIVa rapidly since the resistor Ra is used to speedup discharge of the input power source VIN when the external power source 260 is removed. On the other hand, since the capacitor C in the electronic device 200 is disposed for stabilizing the internal power source VDD, after the external power source 260 is removed, the internal power source VDD can still provide power to the internal circuit 230 for a predetermine period TP. The internal circuit 230 finishes unfinished operations and stores unstored data during the predetermined period TP as soon as possible.

The internal power source VDD is not directly coupled to the input power source VIN since the isolating device 210 is disposed. In this situation, the reaction of the internal power source VDD will not be exactly the same as the input power source VIN. More particularly, when the external power source 260 is removed, the voltage of the input power source VIN drops fast due to the resistor Ra. However, the voltage of the internal power source VDD drops slower than that of the input power source VIN, since the capacitor C is disposed. In other words, the reaction of the internal power source VDD corresponding to the removal of the external power source 260 can be slower than that of the input power source VIN. Therefore, the electronic device 200 can detect the removal of the external power source 260 rapidly, while at the same time, the internal power source VDD can provide power to the internal circuit 230 with a long predetermined period TP.

It can be known from the above illustration that the comparator 220 is set to compare the voltage of the divided power source VDIVa with the reference voltage VREF instead of the voltage of the internal power source VDD. Because the isolating device 210 and the resistor Ra are disposed for the removal of the external power source 260, the reaction of the input power source VIN is faster than the internal power source VDD. Therefore, the comparator 220 can detect the drop of the voltage of the divided power source VDIVa immediately, and generates the removing signal SPL representing “removing” to the internal circuit 230. Consequently, before the voltage of the internal power source VDD drops below a threshold that the internal circuit 230 cannot operate, the internal circuit 230 can prepare to turn off, e.g., finishing unfinished operations and stores unstored data, and then turns off.

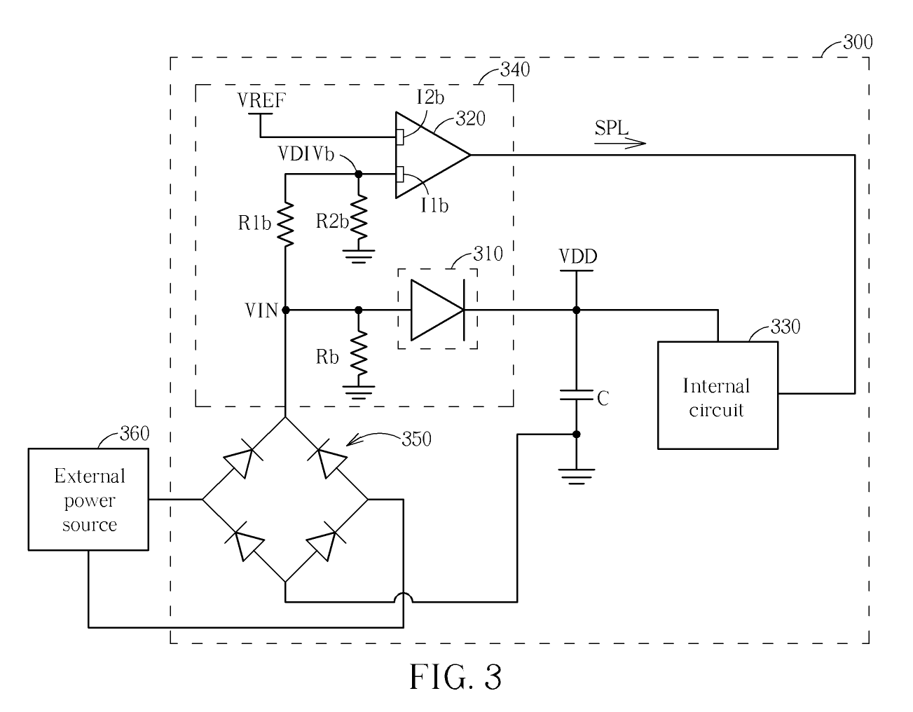

FIG. 3 shows an electronic device 300 with fast power removing detection according to the present invention. The electronic device 300 comprises an internal circuit 330, a resistor Rb, a resistor R1b, a resistor R2b, a capacitor C, a power detecting circuit 340 and a rectifier 350. The power detecting circuit 340 comprises an isolating device 310 and a comparator 320. Additionally, an external power source 360 is coupled to the electronic device 300 for providing an input power source VIN.

The external power source 360 is rectified by the rectifier 350 to generate the input power source VIN. The isolating device 310 of the power detecting circuit 340 isolates the input power source VIN provided by the external power source 360, and accordingly generates an internal power source VDD. In other words, the input power source VIN is converted to the internal power source VDD by the isolating device 310 of the power detecting circuit 340. The isolating device 310 is preferably realized by using a diode. The rectifier 350 can be realized by using a bridge rectifier. The capacitor C is disposed for stabilizing the internal power source VDD so as to maintain the internal power source VDD for a while after the external power source 360 is removed. The resistor Rb is coupled between the input power source VIN and a ground end, and is used to speed up discharge of the input power source VIN when the external power source 360 is removed. The resistor R1b is coupled between the input power source VIN and the input end I1b of the comparator 320; the resistor R2b is coupled between the input end I1b of the comparator 320 and the ground end. The resistors R1b and R2b are used to provide a divided power source VDIVb from the input power source VIN to the input end I1b of the comparator 320.

The comparator 320 determines if the external power source 360 is removed according to a voltage of the divided power source VDIVb, and accordingly sends a removing signal SPL representing “removing” to the internal circuit 330. When the internal circuit 330 receives the removing signal SPL representing “removing”, the internal circuit 330 prepares to turn off, e.g., finishing unfinished operations and stores unstored data, and then turns off.

The comparator 320 compares the voltage of the divided power source VDIVb with a reference voltage VREF which is inputted to the input end I2b of the comparator 320. When the voltage of the divided power source VDIVb is higher than the reference voltage VREF, it means the external power source 360 is still coupled to the electronic device 300 and thus the internal circuit 330 continues to operate regularly. When the voltage of the divided power source VDIVb is lower than the reference voltage VREF, it means the external power source 360 is removed from the electronic device 300, and the comparator 320 immediately sends the removing signal SPL representing “removing” to the internal circuit 330. The comparator 320 detects the drop of the voltage of the divided power source VDIVb rapidly since the resistor Rb is used to speed up discharge of the input power source VIN when the external power source 360 is removed. On the other hand, since the capacitor C in the electronic device 300 is disposed for stabilizing the internal power source VDD, after the external power source 360 is removed, the internal power source VDD can still provide power to the internal circuit 330 for a predetermine period TP. The internal circuit 330 finishes unfinished operations and stores unstored data during the predetermined period TP as soon as possible.

The internal power source VDD is not directly coupled to the input power source VIN since the isolating device 310 is disposed. In this situation, the reaction of the internal power source VDD will not be exactly the same as the input power source VIN. More particularly, when the external power source 360 is removed, the voltage of the input power source VIN drops fast due to the resistor Rb. However, the voltage of the internal power source VDD drops slower than that of the input power source VIN, since the capacitor C is disposed. In other words, the reaction of the internal power source VDD corresponding to the removal of the external power source 360 is slower than that of the input power source VIN. Therefore, the electronic device 300 can detect the removal of the external power source 360 rapidly, while at the same time, the internal power source VDD can provide power to the internal circuit 330 with a long predetermined period TP.

It can be known from the above illustration that the comparator 320 is set to compare the voltage of the divided power source VDIVb with the reference voltage VREF instead of the voltage of the internal power source VDD. Because the isolating device 310 and the resistor Rb are disposed for the removal of the external power source 360, the reaction of the input power source VIN is faster than the internal power source VDD. Therefore, the comparator 320 detects the drop of the voltage of the divided power source VDIVb immediately, and generates the removing signal SPL representing “removing” to the internal circuit 330. Consequently, before the voltage of the internal power source VDD drops below a threshold that the internal circuit 230 cannot operate, the internal circuit 230 can prepare to turn off, e.g., finishing unfinished operations and stores unstored data, and then turns off.

In addition, the external power source 260 can be a DC power source; the external power source 360 can be an AC power source.

In conclusion, the present invention enables an electronic device with fast power removing detection by using an isolating device and a resistor. The isolating device is used to isolate an internal power and an external power such that voltage provided by those powers can drop with different speeds. The resistor is used to speed up the drop of a voltage provided by the external power when the external power is removed. When the external power is removed, the voltage provided by the external power drops fast due to the resistor, and a voltage provided by the internal power drops slowly by using a capacitor. Therefore, the electronic device can detect the removal of the external power rapidly. At the same time, there is enough time for the electronic device to finish unfinished operations and store unstored data before the voltage provided by the internal power drops below a threshold that the electronic device can operate.

Those skilled in the art will readily observe that numerous modifications and alterations of the device and method may be made while retaining the teachings of the invention.

What is claimed is:

1. A power detecting circuit with fast power removing detection, comprising:
an isolating device, coupled between an external power source and an internal power source, for isolating the external power source and the internal power source; and
a comparator, coupled to the external power source, for determining if the external power source is removed, and accordingly generating a removing signal;
wherein the internal power source is provided to an internal circuit;
wherein the comparator is coupled to the internal circuit;
wherein the internal circuit prepares to turn off and turns off according to the removing signal.

2. The power detecting circuit of claim 1, wherein when a voltage of the external power source is lower than a reference voltage, the removing signal generated from the comparator represents removing.

3. The power detecting circuit of claim 2, wherein when the removing signal received by the internal circuit represents removing, the internal circuit prepares to turn off and turns off.

4. The power detecting circuit of claim 1, further comprising a capacitor coupled to the internal circuit.

5. The power detecting circuit of claim 1, wherein the isolating device is a diode.

6. The power detecting circuit of claim 1, wherein the external power source is a DC power source.

7. The power detecting circuit of claim 1, wherein the external power source is an AC power source.

8. The power detecting circuit of claim 1, wherein the isolating device is coupled to the external power source through a rectifier.

9. The power detecting circuit of claim 1, wherein the internal circuit prepares to turn off by finishing unfinished operations and storing unstored data.

10. An electronic device with fast power removing detection, comprising:
an internal power source, for receiving an external power source for accordingly providing power;
an internal circuit, coupled to the internal power source for receiving the power provided by the internal power source, to operate, prepare to turn off and turn off according to a removing signal; and
a power detecting circuit, comprising:
an isolating device, coupled between the external power source and the internal power source, for isolating the external power source and the internal power source; and
a comparator, coupled to the external power source, for determining if the external power source is removed, and accordingly generating the removing signal.

11. The electronic device of claim 10, wherein when a voltage of the external power source is lower than a reference voltage, the removing signal generated from the comparator represents removing.

12. The electronic device of claim 11, wherein when the removing signal received by the internal circuit represents removing, and the internal circuit prepares to turn off and turns off.

13. The electronic device of claim 10, further comprising a capacitor coupled to the internal circuit.

14. The electronic device of claim 10, wherein the isolating device is a diode.

15. The electronic device of claim 10, wherein the external power source is a DC power source.

16. The electronic device of claim 10, wherein the external power source is an AC power source.

17. The electronic device of claim 10, wherein the isolating device is coupled to the external power source through a rectifier.

18. The electronic device of claim 10, wherein the internal circuit prepares to turn off by finishing unfinished operations and storing unstored data.

19. A method of handling fast power removing detection for an electronic device, comprising:
detecting if an external power source is removed, and accordingly generating a removing signal; and
preparing to turn off and turning off an internal circuit of the electronic device according to the removing signal.

20. The method of claim 19, wherein detecting if the external source is removed, and accordingly generating the removing signal comprises:
when a voltage of the external power source is lower than a reference voltage, generating the removing signal representing removing.

21. The method of claim 20, wherein turning off the internal circuit of the electronic device according to the removing signal comprises:
when the removing signal represents removing, preparing to turn off and turning off the internal circuit of the electronic device.

22. The method of claim 19, wherein preparing to turn off the internal circuit of the electronic device according to the removing signal comprises:
preparing to turn off the internal circuit of the electronic device according to the removing signal by finishing unfinished operations and storing unstored data.
